(19) United States
(12) Patent Application Publication
(10) Pub. No.: US 2015/0083770 A1
(43) Pub. Date: Mar. 26, 2015

(54) LOAD CARRIER HAVING A COUPLING DEVICE

(71) Applicant: Stefan Ziola, Wolpertswende (DE)

(72) Inventor: Stefan Ziola, Wolpertswende (DE)

(21) Appl. No.: 14/397,328

(22) PCT Filed: May 1, 2013
(86) PCT No.: PCT/EP2013/059062

§ 371 Date: Oct. 27, 2014

(30) Foreign Application Priority Data
May 11, 2012 (DE) 20 2012 101 729.6

(51) Int. Cl. B60R 9/06

(52) U.S. Cl. CPC B60R 9/06
USPC 224/501

(57) ABSTRACT

The invention relates to a foldable load carrier (1) with at least one adjusting range (8), on which load to be transported, especially at least one bicycle, can be placed, and a coupling mechanism (2), which can be detachably attached at a receptacle-like coupling (3) with a substantially square opening (3a), in which the extracting of at least one latch (25) and the locking of the at least one latch (25) with a locking device (21) is done by a swinging movement around a pivoting axis (ST) of a single lever (10) serving as control element, and that the lever (10) serving as control element at the same time also forms the adjusting range (8).

The invention relates to a load carrier, especially rear-mounted carrier, with a coupling mechanism for fastening at a motor vehicle, which presents a coupling with a square opening according to SAE J684, according to the preamble of claim 1.

From U.S. Pat. No. 7,240,816 B2 a load carrier is known, in which a central carrier bears tip-up carrier arms, on which adjusting ranges for bicycles are provided, and that carries a support with hook-shaped holders for holding the bicycles. The attachment of the central carrier at a US-coupling with square opening the central carrier is formed with a corresponding cross-section that fits into the opening. The end is introduced into the opening and secured with a lock. Mounting and fixing the load carrier is relatively laborious. Moreover the lock has to be additionally secured, for example with a split pin or a lock.

The aforementioned load carrier thus leaves room for improvement, especially with regard to the fixing on a vehicle with a receptacle-like coupling (i.e. “receiver type hitch”).

From DE 10 2010 036 898 A1 moreover a collapsible load carrier for mounting on a trailer hitch with a spherical head is known, that has two tip-up adjusting ranges, on which as far as two bicycles can be placed. The load carrier is formed by a base and a carrier arrangement pivotably connected with the base. One of the carrier frames serves for the movement of a clamp over the spherical head of the hitch, the other carrier frame serves for the real tensioning. Such an embodiment in the event of operating errors can result in damages. Especially a predetermined order in folding down the carrier frames has to be maintained in the operation.

The invention therefore is based on the task to improve a load carrier, especially with regard to mounting and fixing at a receptacle-like coupling of a motor vehicle.

This object is solved according to the invention by a load carrier with the characteristics of claim 1. Advantageous embodiments are object of the sub-claims.

By providing a foldable load carrier in which extracting and locking is done with a locking device by a swinging movement around a pivoting axis of a single lever serving as control element, in which the lever serving as control element at the same time also forms the adjusting range, a very simple actuation of the locking device results. Especially such a lever is easily accessible. By using a movement for locking, that is also necessary without locking, in order to make the load carrier usable, a simplified, safe assembly results. Especially by using an adjusting range as control element it can be ensured that the load carrier is correctly locked, since the user can ascertain in a simple way if the load carrier is unfolded correctly and thus is ready for use.

If the swinging movement of the lever is transmitted to the coupling mechanism by means of a gearing and if the gearing transforms the swinging movement of the lever downwards into an extraction of at least one latch, which is part of the locking device, and the swinging movement of the lever upwards into a retracting movement of said latch, a simple technical transformation of the swinging movement into a locking movement results.

Preferably a part of the gearing is a camshaft, which presents at least one cam that interacts with the latch. Especially preferably it is a double cam, formed by two cams displaced by 180°. Each of the cams interacts with a latch.

Although in the following load carriers are referred to as so-called rear-mounted carriers, in case of special vehicles the trailer hitch can also be provided at another side of the vehicle, for example at the front side. Of course the load carrier according to the invention can be also used in those cases.

In the following the invention will be explained more in detail on the basis of an embodiment with reference to the included drawing. The figures show:

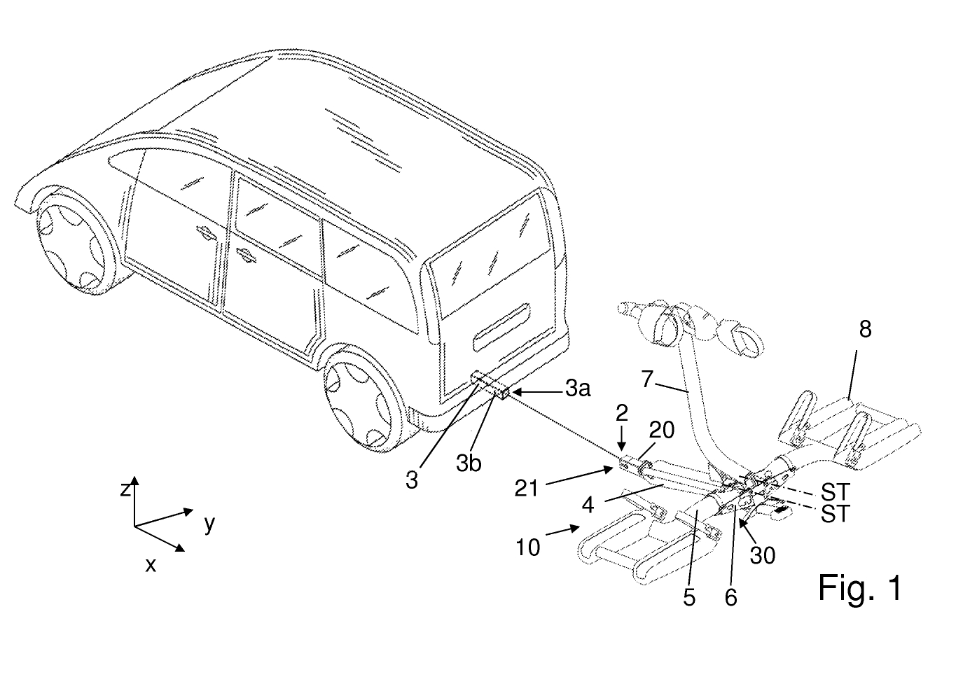

FIG. 1 a perspective explosive view of the load carrier according to the invention in operative condition with a motor vehicle,

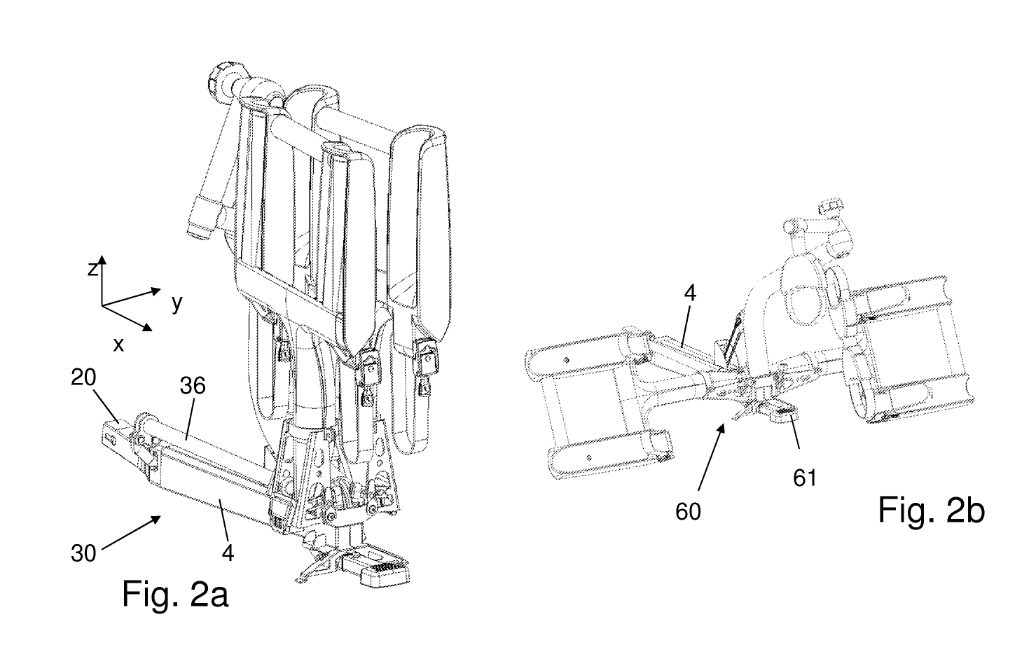

FIG. 2a a perspective view of the load carrier in the folded state corresponding to FIG. 1,

FIG. 2b a perspective view of the ready for operation load carrier in backwards tilted state corresponding to FIG. 1,

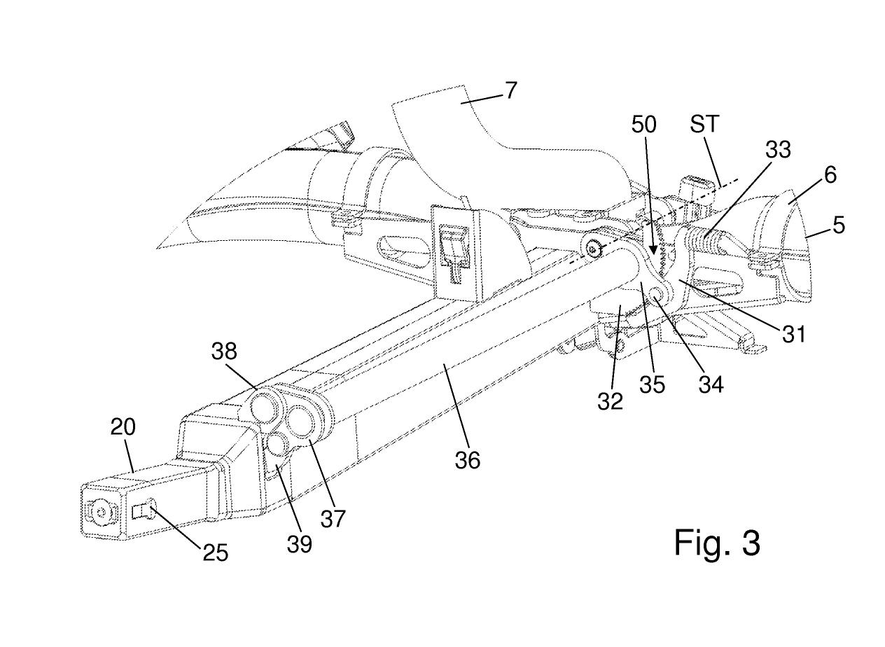

FIG. 3 a detail view of the coupling mechanism of the load carrier of FIG. 1 in operative condition from another perspective,

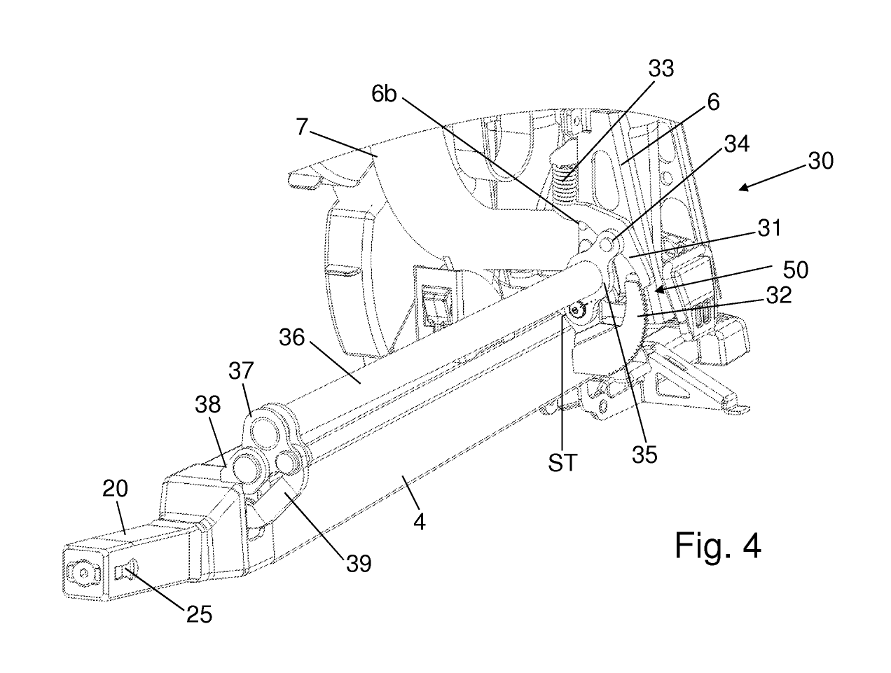

FIG. 4 a view corresponding to FIG. 3 in the folded state,

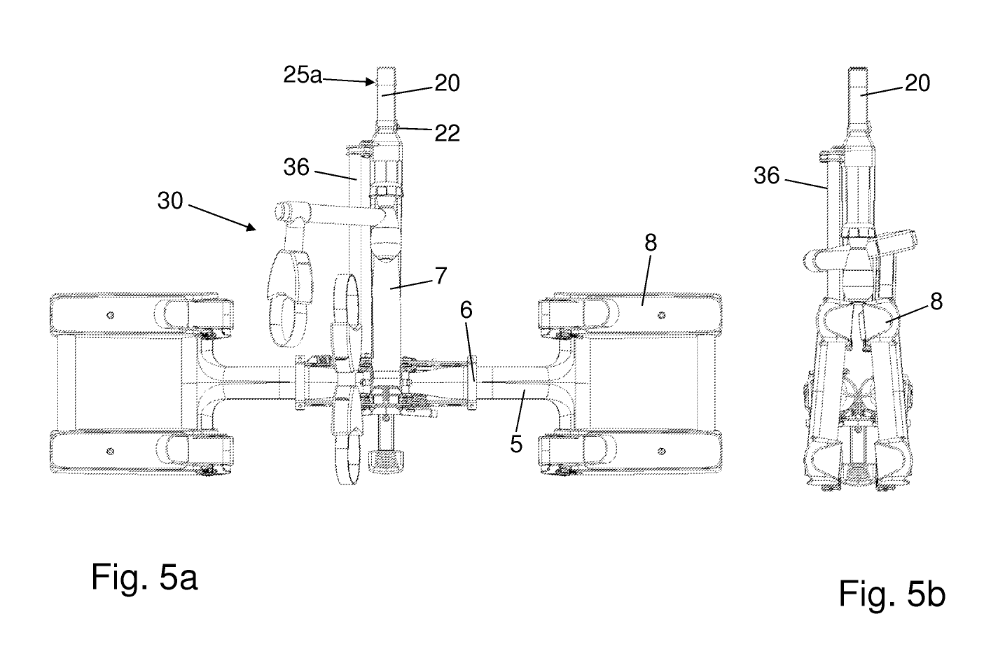

FIG. 5a a top view on the load carrier of FIG. 1 in operative condition,

FIG. 5b a view corresponding to FIG. 5a in the folded state,

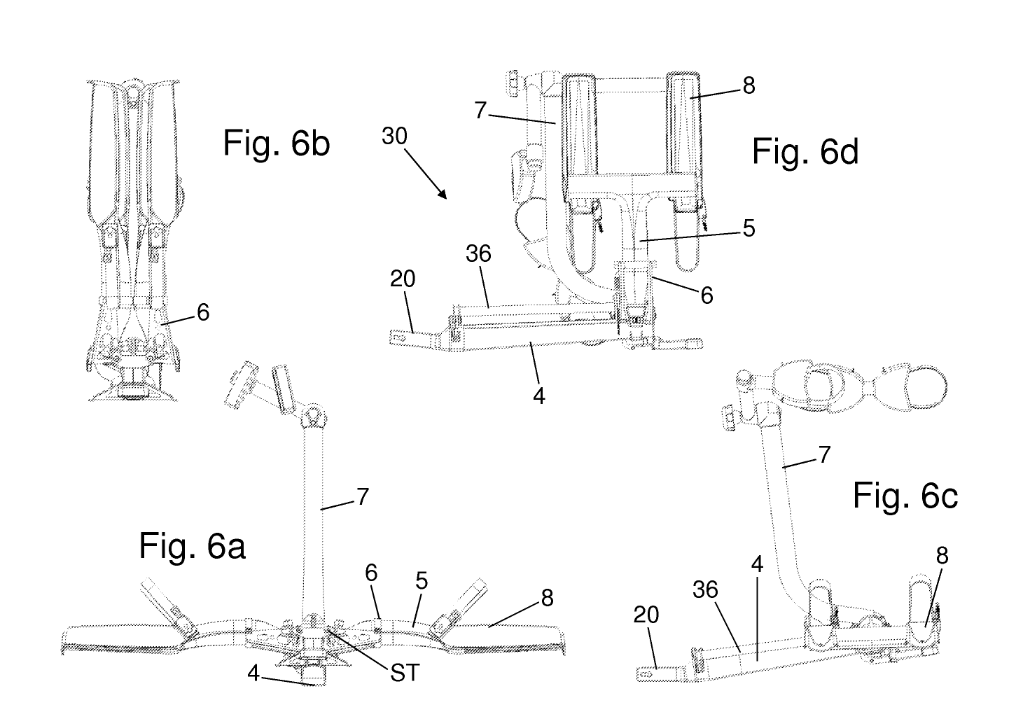

FIG. 6a a view of the load carrier in operative condition from behind,

FIG. 6b a view corresponding to FIG. 6a in the folded state,

FIG. 6c a side view of the load carrier in operative condition from the left,

FIG. 6d a view corresponding to FIG. 6c in the folded state,

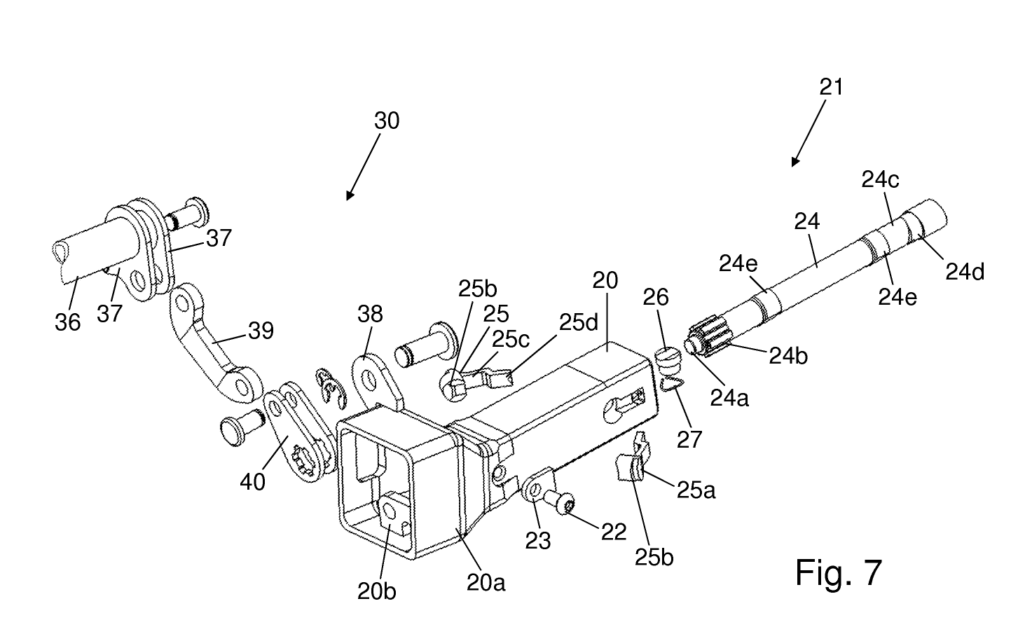

FIG. 7 an exploded view of the substantial parts of the coupling mechanism,

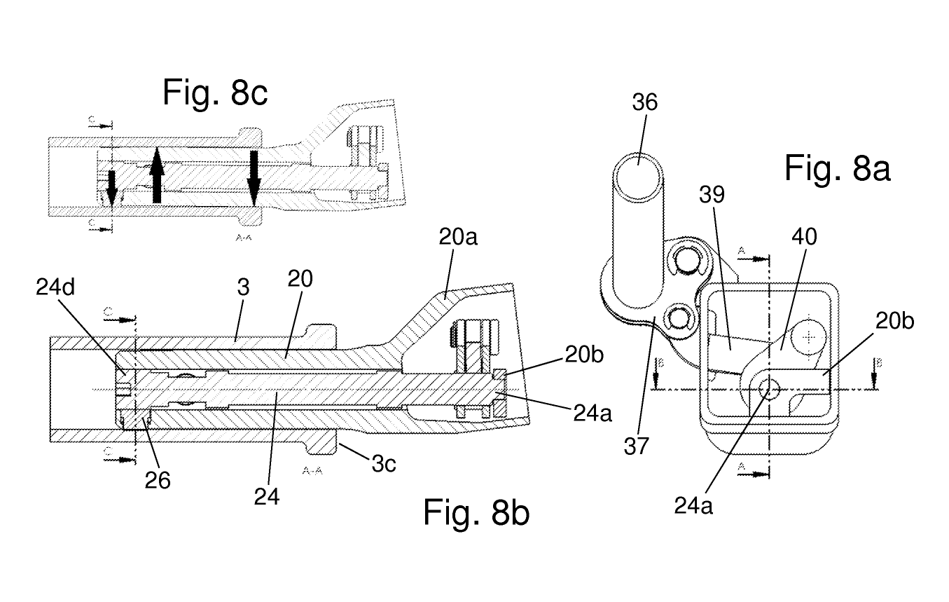

FIG. 8a a view of the ready for operation coupling mechanism in travel direction,

FIG. 8b a section along line A-A in FIG. 8a,

FIG. 8c a representation corresponding to FIG. 8b with schematic representation of forces,

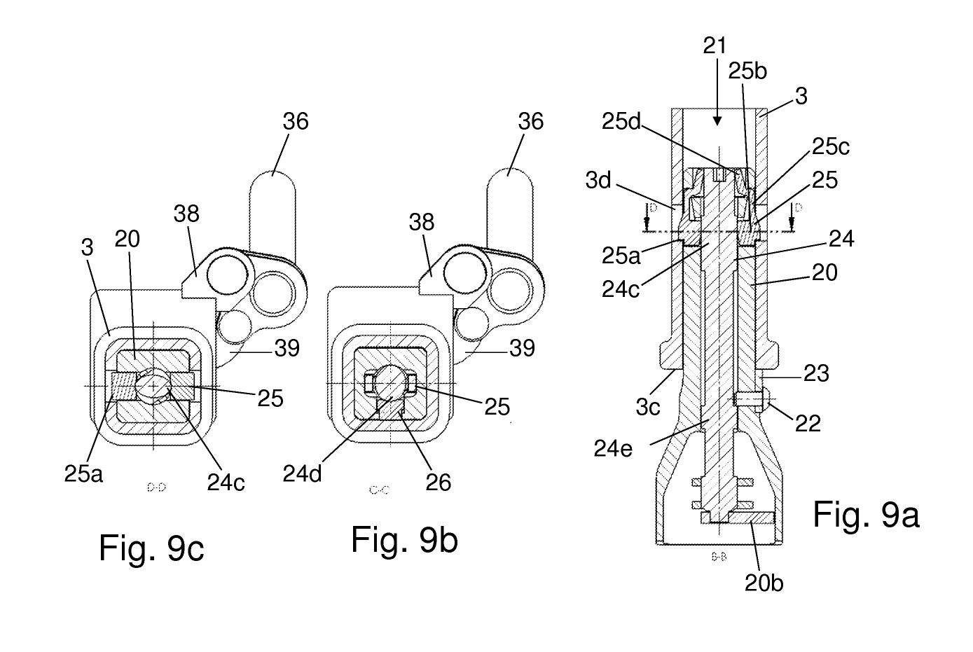

FIG. 9a a section along line B-B in FIG. 8a,

FIG. 9b a section along line C-C in FIG. 8b,

FIG. 9c a section along line D-D in FIG. 9a,

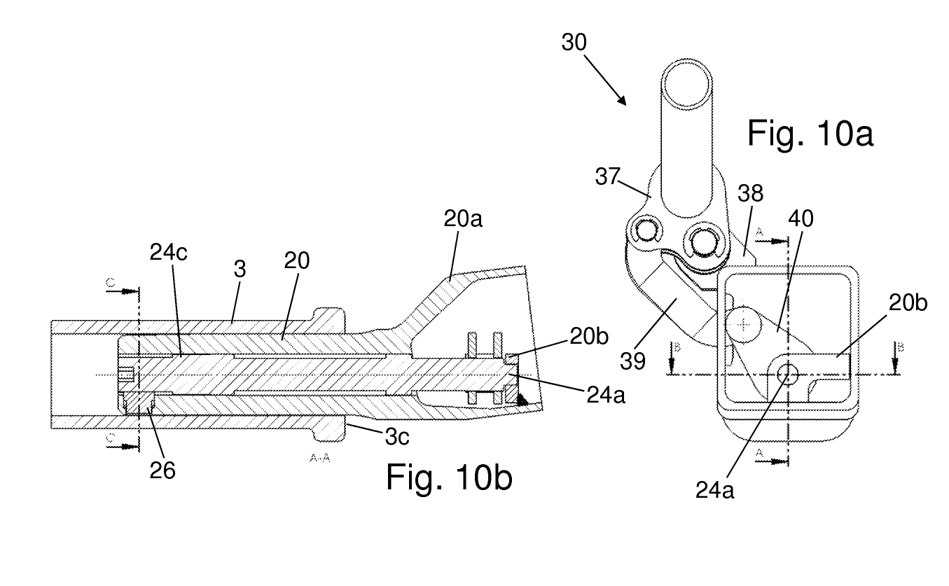

FIG. 10a a view of the coupling mechanism in travel direction with folded load carrier,

FIG. 10b a section along line A-A in FIG. 10a,

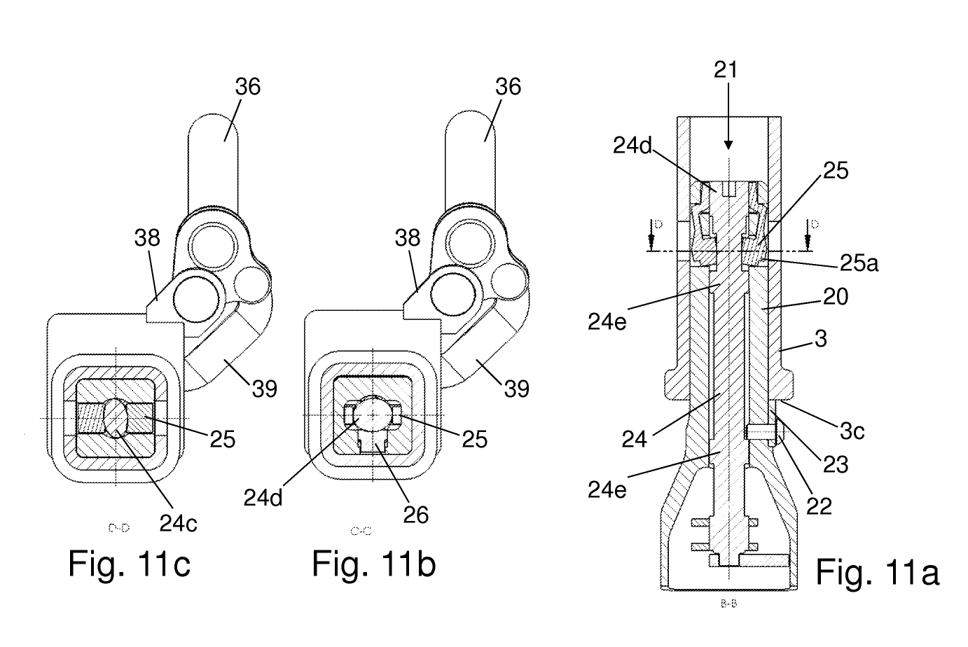

FIG. 11a a section along line B-B in FIG. 10a,

FIG. 11b a section along line C-C in FIG. 10b,

FIG. 11c a section along line D-D in FIG. 11a,

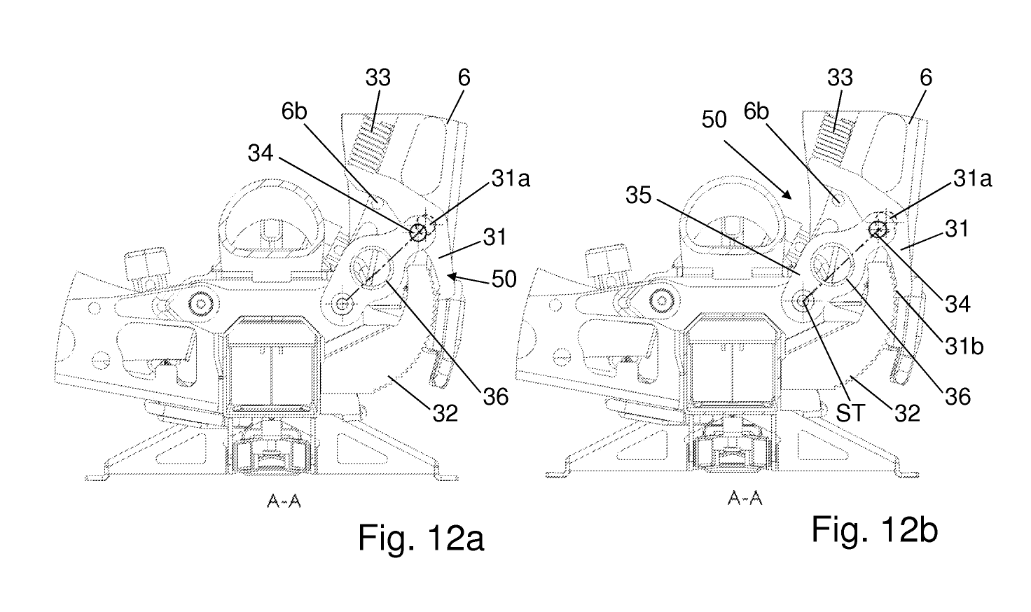

FIG. 12a a detail view of the force limitation of the coupling mechanism in the disengaged state,

FIG. 12b a detail view of the force limitation of the coupling mechanism in the retracted state, and

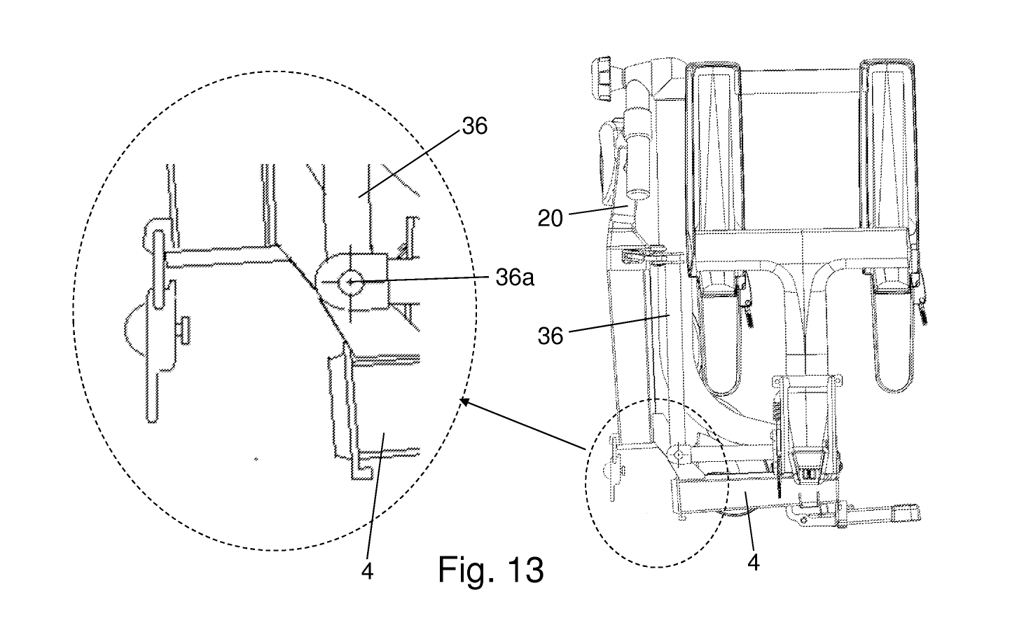

FIG. 13 a side view of a further collapsible variant of the load carrier of FIG. 1.

The following description is based on a load carrier 1 applied as rear-mounted carrier at a trailer hitch, as shown in FIG. 1 in an explosive view. The directions refer to the normal travel direction of the vehicle, in which X indicates the direction contrary to the travel direction, Y the transversal direction and Z the vertical direction.

A foldable load carrier 1, that in this case may serve for the transport of two bicycles or other loads, like for example skis, snowboards, a rear box, is to be fastened with the help of a coupling mechanism 2 at a receptacle-like coupling 3 of a motor vehicle. The receptacle-like coupling 3 has an end zone substantially designed as a rectangular tube with a backwards open locating opening 3a with square cross-section as well as two lateral locking openings 3b. In this case it is a 1.25″ Hitch Mount Receiver, which is usually used for trailer devices Class I and Class II. The design may however also be accordingly larger for a 2″ Hitch Mount Receiver for Class III and Class IV or for a 2.5″ Hitch Mount Receiver for Class V. Especially with the larger couplings instead of the two bicycles described in the following also for example four or five bicycles can be transported. Moreover known reducing sleeves can be used for the larger couplings, so that also the coupling mechanism 2 can be used for 1.25″ Hitch mount receiver.

The load carrier 1 has a central carrier 4, which, if the load carrier 1 is applied correctly to a motor vehicle as a rear-mounted carrier, extends in longitudinal direction of the vehicle and in cross-section substantially presents the form of a closed hollow profile. At one end of the central carrier 4 the coupling mechanism 2 is arranged, at the other end of the central carrier 4 there is the collapsible part of the load carrier 1 that forms the actual charging area. For this purpose two carrier arms 5 are applied, by means of consoles 6 centrically as to the semilongitudinal axis of the central carrier 4 pivotably around two carrier arm-swinging axles ST spaced from each other, the carrier arms 5 in their folded position being arranged substantially parallelly to each other and substantially aligning with each other in their unfolded ready for action position. A support bracket 7 roughly bent by 90° is arranged with its horizontal leg above the central carrier 4, between the tiltable ends of the carrier arms 5, and extends with its vertical leg slightly distanced from the coupling mechanism 2 upwards.

Although not described in detail, in an alternative embodiment the consoles with carrier arms can also be arranged on the central longitudinal axis of the central carrier, i.e. the two carrier arm swinging axles are aligned with each other.

If one, with the unfolded load carrier 1, for example wants to transport two bicycles, the same are parallel to each other, oriented in y direction, with their wheels on accordingly formed adjusting ranges 8 at the carrier arms 5 and in the upper area they are connected with the support bracket 7 in a manner known per se, by means of holders, clips, brackets or similar, not shown in detail. The carrier arms 5 are formed in such a way, that they are arranged rotatably around its longitudinal axis in the respective console 6, so that the adjusting ranges 8 formed bifurcated on it for the load to be carried, if not used, can be oriented in a space saving way. If in use, the carrier arms 5 however are form-fit connected with the support bracket 7 and mounted in their consoles 6. Alternatively the carrier arms can also be arranged rigidly in the consoles or where applicable also be formed one-piece with them. Because of its function the totality of console 6 and carrier arm 5 as well as the adjusting range 8 are also called lever 10. For actuating a corresponding handle, not represented, can be formed on all areas or rigidly be connected to them.

In the unfolded ready for operation position of the load carrier 1 in this case, as illustrated in FIG. 2b, a tilt of the carrier arms 5 with their adjusting ranges 8 with support bracket 7 backwards is possible, so that for example the boot is accessible. The carrier arms 5 are rotatable within the consoles 6. A security device arranged between the central carrier 4 and the extrados of the support bracket delimits the tilt. As the carrier arms 5 are connected to each other, in the folded state of the load carrier 1 a tilt is not possible, since a rotation within the consoles 6 is prevented due to the connecting area between the carrier arms 5. An additional security device can be provided, in order to prevent an unwanted tilting in the operative condition. For tilting, for example in order to get to the boot of the vehicle, the security device if existing is released and the carrier arms 5 can be tilted backwards in the consoles 6. Due to the relatively large operating forces, especially due to the friction between carrier arms 5 and consoles 6 in an area with relatively large diameter, an inadvertent tilt backwards is prevented even without additional security device.

The carrier arm 5 here arranged on the left in travel direction of the vehicle is at the same time an actuating element for the coupling mechanism 2, while the second carrier arm 5 in this case has no additional function connected to the coupling mechanism 2.

In the following the structure and the function of the coupling mechanism 2, which serves for safely connecting the load carrier 1 with the receptacle-like coupling 3, are described in more detail.

The actual coupling area, thus the area in which the load carrier 1 is connected with the receptacle-like coupling 3, has as constitutive parts a mandrel 20 stationary with respect to the central carrier 4 and a locking device 21 movable with respect to it. For mounting the load carrier 1 to the receptacle-like coupling 3 the mandrel 20 is pushed in up to a stop plate 23 applied to the outside of the mandrel 20 by means of a fixing screw 22. As the overall dimensions of the mandrel 20 and internal dimensions of the receptacle-like coupling 3 substantially correspond to each other, an insertion is possible with precisely specified orientation, wherein the insertion depth is defined by the stop plate 23 which abuts at the front end face 3c of the receptacle-like coupling 3 (see FIGS. 9a and 11a).

The locking device 21, which is arranged substantially inside the mandrel 20 and inside a transition area 20a, connected one-piece with the mandrel 20, towards the central carrier 4, has a camshaft 24, two latches 25, a pressure piece 26 and a wave spring 27. For actuating the locking device 21 an operating means 30 is provided, which interacts with the camshaft 24 of the locking device 21. The movement transmission from the operating means 30 to the locking device 21 will be explained later.

Before explaining the operating means 30 more in detail, the locking device 21 is described in more detail in the following.

The camshaft 24 has a journal 24a arranged on the side of the central carrier 4, rotatable in a bedplate 20b provided in the transition area 20a towards the central carrier 4. Adjacent to the journal 24a teeth 24b are formed. It should be pointed out that the teeth 24b need not be formed necessarily as toothed area, but rather the camshaft 24 has to be suitable for the movement transmission. In an open building method or an assembly from the other side for example arms protruding outwards can take over the transfer function.

At the coupling side end the camshaft 24 there are two double cams 24c and 24d arranged twisted by 90° towards each other, each formed by two cams displaced by 180° towards each other, as well as a first bearing 24e between the double cam 24c and the teeth 24b, flattened for the assembly. A second bearing 24e includes with the first bearing 24e an unsupported area between itself (see FIG. 11a). The double cams 24c and 24d appear with the latches 25 jointly, wherein the latches 25 have a thicker locking area 25b with a catch 25a, a connecting area 25c and a thinner deactivation area 25d. In the locked state of the load carrier 1 the catch 25a of the latches 25 protrudes each time into lateral openings 3d of the receptacle-like coupling 3, as for example illustrated in FIG. 9a. As the double cams 24c press from inside against the locking area 25b, the noses 25a are fixed in their position and prevent a withdrawal of the mandrel 20 from the receptacle-like coupling 3. Due to the corresponding profiles of mandrel 20 and receptacle-type coupling 3, of the stop plate 23 that interacts with the frontal surface 3c of the receptacle-like coupling 3, and of the noses 25a of the latches 25 that protrude into the openings 3d of the receptacle-like coupling 3, there is a form-fitness and the load carrier 1 cannot be removed.

For the backlash-free position of the mandrel 20 said pressure piece 26 is provided in connection with a chamfer at the upper side of the mandrel 26. For clarification of the working forces three arrows are drawn schematically in FIG. 8c. Here the chamfer has an angle of ca. 1° with respect to the longitudinal axis of the mandrel 26 and finishes in the area of the middle arrow of FIG. 8c, i.e. the area of the chamfer end forms a first adhesion area, in which due to the elastic (and where applicable plastic) deformation of the surfaces adhering to each other, no pressure peaks will occur but the pressure is well distributed. As an alternative to a backlash-free position by means of said chamfer also other measures are possible in order to realize a backlash-free position forming adhesion of the mandrel 20 in three areas as illustrated in FIG. 8c, for example a heel or a camber can be provided at the mandrel 20.

The pressure piece 26 protrudes, as shown in FIG. 8b, through an opening in the mandrel 20 downwards and adheres to the inner surface of the locating opening 3a of the receptacle-like coupling 3. It is pressed from the top downwards by the end zone of the camshaft 24s, wherein the camshaft 24s forwards the force to the opposite side of the mandrel 20.

Due to the weight of the load carrier 1 in connection with a slight elastic deformation of the mandrel 20 moreover the bottom of the mandrel 20 adheres to the front end of the locating opening 3a (right arrow). Also in this area there are, due to the elastic (and where applicable plastic) deformation of the surfaces adhering to each other, no pressure peaks, but the pressure is well distributed.

By the three adhesion areas of the mandrel 20 the same is mounted without backlash in the receptacle-formed coupling 3 so that in operation rattling noises are prevented.

In the folded state of the load carrier 1 the camshaft 24 is in a position rotated by ca. 90°, so that the double cams 24c do not adhere any longer from inside to the latches 25, but the “thin” area between the double cams 24c makes possible a retraction of the latches 25. The retraction of the latches 25 is caused by the second double cams 24d that due to the rotation of the camshaft 24 adhere to the thinner deactivation area 25d of the latches 25 and press the same during the rotation movement outwards, by which the latches 25 with their coupling side end are pressed outwards radially in relation to the camshaft 24, so that they with their locking area 25b released by the first double cams 24c due to the rotation of the camshaft 24 from inside are moved inwards and the noses 25a are moved out of the openings 3d. The load carrier 1 can thus be removed from the receptacle-like coupling 3.

In the following the operating means 30, which drives the locking device 21 and holds it in its final positions, is described in more detail.

For a defined locking and securing of the coupling mechanism 2 on the coupling-side outer side of the left console 6 a catch device is arranged, which has a detent 31 that interacts with a tooth segment 32 that is applied at the central carrier 4, and presents a prestressed spring 33 which serves as prestressing element. The detent 31 of the catch device has an axis 31a formed at the detent 31, with which it is pivotably mounted in a bearing at the outer side of the console 6. The detent 31 moreover has two outwards extending ends, in which at one end in this case two click teeth 31b are formed. Of course also a different suitable number of click teeth can be provided. The other end of the detent 31 adheres to the prestressing spring 33. On the side opposite to the spring 33 a stopper 6b for the detent 31 is provided, wherein the spring 33 holds the corresponding leg of the detent 31 in adhesion to the stopper 6b.

On the detent 31, slightly displaced with respect to the axis 31a that bears the detent 31 on the console 6, a bolt 34 is provided, which bears a follower plate 35 pivotably and thus forms a second bearing. The follower plate 35 is mounted by means of a further bolt at the opposite end additionally pivotably in the carrier arm pivoting axis ST. The follower plate 35 is moreover, roughly between the bolt 34 and the carrier arm pivoting axis ST, fixed to a transmission element 36, here in the form of a tube. This tube can deform elastically slightly in case of torsional strains, i.e. it serves as torsional element and thus as additional compensation element. At the other end, the coupling side end of the transmission element 36 in this case two roughly triangular plates 37 are arranged parallelly and slightly distanced from each other. The plates 37 in one corner are fixed to the transmission element 36, i.e. not twistable. The triangular plates 37 are supported in a second corner by an arm 38 forming a bearing and protruding from the transition area 20a, by means of a bolt. In the third corner between the plates 37 by means of a further bolt one end of a connecting rod 39 is pivotably supported. With the second end of the connecting rod 39 by means of a further bolt two elongate crank latches 40 are pivotably connected, which take up the connecting rod end between themselves. The crank latches 40 at the other end, spaced from the connecting rod 39, have an opening, with which they rest form-fit on the teeth 24b of the camshaft 24. Thus the crank latches 40 can transmit adjusting movements to the camshaft 24.

In the following the handling of the load carrier 1, especially the function of the operating means 30 in connection with the locking device 21, will be described in more detail. For assembling the load carrier 1 the mandrel 20 is introduced into the locating opening 3a of the receptacle-like coupling 3, until the stop plate 23 adheres to the front frontal surface 3c and the insertion movement is automatically stopped. The two carrier arms 5 of the load carrier 1 are here directed upwards, i.e. the load carrier is in its folded position.

Afterwards the two carrier arms 5 are folded down, in this case the in travel direction right carrier arm 5 has no locking function. The order of folding down is as a matter of principle indifferent, it is however advantageous if first the carrier arm 5 is folded down, which has a locking function.

When folding down the in travel direction left carrier arm 5, from the position in FIG. 2a into the position of FIG. 1, the console 6 pivots around the carrier arm pivoting axis ST. The console 6, which bears the axis 31a of the detent 31, entrains the detent 31 and thus also the follower plate 35 with transmission element 36, wherein the follower plate 35 roughly like the console 6 pivots around the carrier arm pivoting axis ST.

For avoiding an overload or damage if the mandrel 20 is not inserted correctly into the locating opening 3a of the coupling 3, a force limitation 50 is provided, which is formed by the detent 31 with the tooth segment 32, the spring 33, the stopper 6b, and especially the offset arrangement of axis 31a and bolt 34.

If the operating force at the carrier arm 5 becomes too great, the pin of the detent 31 with the spring 33 detaches from the stopper 6b and compresses the spring 33 more. This leads to a twist of the detent 31, by which the click teeth 31b mesh with the teeth of the tooth segment 32 and block the movement (FIG. 12b). A further increase of the force leads to a reinforcement of the teeth mesh. In this way a swinging down of the console 6 with the carrier arm 5 incorporated in is blocked.

A slight relief releases the mesh and the folding down of the carrier arm 5 with console 6 can be continued (FIG. 12a), if the operating force does not become too great. By the dimensioning of the spring 33 it can be ensured that a sufficient force for actuating the locking device 21 can be applied, but a damage to the same can be prevented in a safe way.

As a matter of principle the force limitation 50 with detent 31, tooth segment 32, spring 33, stopper 6b, axis 31a and bolt 34 can also be omitted, so that the follower plate 35 can be part of the console 6, or the transmission element 36 can be applied directly at the console 6.

Swinging down the follower plate 35, entails a corresponding movement of the transmission element 36, which the triangular plates 37, that are supported with one corner on the rigid arm 38 of the transition area 20a of the mandrel 20, transmit to the connecting rod 39, wherein a stroke movement transfers on the crank latch 40 (see especially FIGS. 10a and 13). The crank latch 40 rotates by ca. 90° around the central longitudinal axis of the camshaft 24 and entrains, due to the positive connection in the rotation movement, the camshaft 24.

Due to the rotation movement of the camshaft 24 the position of the double cams 24c and 24d inside the mandrel 20 changes. In this way the noses 25a of the latches 25 from the position illustrated in FIG. 11b are pressed outwards, as illustrated in FIG. 9c, penetrating into the locking openings 3b of the receptacle-like coupling 3 and resting on the edge of the locking openings 3b, as illustrated in FIG. 9a.

At the same time the other double cam 24d frees the deactivation area 25d of the latches 25 so that they from their position pressed outwards, as illustrated in FIG. 11b, can move further inwards, as illustrated in FIG. 9a. In this unilateral unfolded state of the load carrier 1, just by that only swinging movement of the console 6 with carrier arm 5, the coupling mechanism 2 is thus completely locked, tensed, and secured in the receptacle-like coupling 3.

The following swinging down of the second console 6 with second carrier arm 5 and its corresponding locking in the horizontal position, in order to make the load carrier 1 ready for action, has no influence anymore on the tensioning of the coupling mechanism 2. The carrier arms 5 (or the consoles 6) can be secured in the unfolded position additionally with a security device, in order to be able to safely avoid an unwanted detachment. Such an additional security device is advantageous, especially when the load carrier 1 is used in the unloaded state, however not indispensable.

As a matter of principle also the second console 6 with second carrier arm 5 can be swung down and locked first.

The dismount of the load carrier 1 from the traction coupling 3 is done by removing the additional security device, if provided, and folding up console 6 (without tensioning function) with carrier arm 5. Afterwards the second console 6 with carrier arm 5 is folded upwards, by which the follower plate 35 is swung around the carrier arm pivoting axis ST upwards entraining the transmission element 36. The movement of the transmission element 36 is transmitted to the connecting rod 39 over the triangular plates 37, that are supported with one corner at the rigid arm 38 of the transition area 20a of the mandrel 20, which connecting rod transmits a tension movement to the crank latch 40 (see especially FIGS. 8a and 10a). The crank latch 40 rotates back by ca. 90° around the central longitudinal axis of the camshaft 24 and, due to the positive connection in the rotation movement, entrains the camshaft 24.

Due to the rotation movement of the camshaft 24 again the position of the double cams 24c and 24d inside the mandrel 20 changes. In this way the double cam 24d presses the deactivation area 25d of the latches 25 outwards, by which the latch 25 slightly tilts and the noses 25a of the latches 25 from the position illustrated in FIG. 9a are returned inwards, as illustrated in FIG. 11a, wherein the noses 25a of the latches 25 leave the locking openings 3b of the receptacle-like coupling 3 and release the load carrier 1. The load carrier 1 can now be removed from the vehicle in the folded position.

As can be seen in the aforementioned functional description, the operating means 21 in connection with the locking device 30 forms a gearing which transforms a simple swinging movement into an extracting or retracting movement of latches 25.

In this case the gearing is a combination of lever and cam mechanism. As a matter of principle however also a transformation of the movement by other types of gearings is possible.

The load carrier 1 according to the present embodiment moreover can be tilted downwards around an axis extending in y direction away from the vehicle, in order to facilitate loading and unloading or to make accessible the boot of the vehicle (see FIG. 2b). For this purpose a tilting device 60 with a pedal 61 is provided. The tilting is possible thanks to the fact, that the carrier arms 5 are incorporated in the consoles 6 in alignment with each other. Moreover the carrier arms 5 in this case are connected with each other by joints (not shown) so that in closed position a tilt is not possible.

In the above described embodiment the load carrier 1 is used in either instance as a rule in the completely unfolded state. As a matter of principle however, as the second lever (console, carrier arm, adjusting range) has no tensioning function, the same can also be used in the folded upwards state. Moreover, according to a further variant not represented in the drawing, the second lever can also be completely omitted.

According to a variant shown in FIG. 13 of a load carrier according to the invention 1—as the only difference to the above described embodiment—additionally also the coupling area 2 can be folded upwards, so that a particularly small folded product size of the load carrier 1 in the folded state results. For this purpose the central carrier 4 is formed in two parts and the transmission element 36 has a joint 36a.

### LIST OF REFERENCE SIGNS

1 Load carrier
2 Coupling mechanism
3 Receptacle-like coupling (“receiver type hitch”)
3a Locating opening
3b Locking opening
3c Front end face
3d Opening
4 Central carrier
5 Carrier arm
6 Console (for carrier arm)
6b Stopper
7 Support bracket
8 Adjusting range
10 Lever
20 Mandrel
20a Transition area
20b Bedplate
21 Locking device
22 Fixing screw
23 Stop plate
24 Camshaft
24a Journal
24b Teeth
24c First double cams
24d Second double cams
24e Bearing
25 Latch
25a Catch
25b Locking area
25c Connecting area
25d Deactivation area
26 Pressure piece
27 Wave spring
30 Operating means
31 Detent
31a Axis
31b Catch tooth
32 Tooth segment
33 Spring
34 Bolt
35 Follower plate
36 Transmission element
36a Joint
37 Triangular plates
38 Arm
39 Connecting rod
40 Crank latch
50 Force limitation
60 Tilting device
61 Pedal
ST Carrier arm pivoting axis

1-15. (canceled)

16. A foldable load carrier mountable on a vehicle for transporting of one or more bicycles, said foldable load carrier comprising:
at least one lever configured to support a portion of at least one bicycle;
a coupling mechanism configured to be detachably attached at a receptacle coupling of a vehicle, said coupling mechanism including at least one latch and a locking device configured to lock said latch by a swinging movement of said lever around a pivoting axis.

17. The foldable load carrier according to claim 16, wherein said swinging movement of said lever is transmitted to said coupling mechanism by a gearing, and that said gearing transforms said swinging movement of said lever downwards into an extraction of said latch, which is part of said locking device, and said swinging movement of said lever upwards into a retracting movement of said latch.

18. The foldable load carrier according to claim 17, wherein said gearing further comprises a camshaft, which presents at least one cam that interacts with a locking area of said latch.

19. The foldable load carrier according to claim 18, wherein said latch is at least two latches, and that said cam is part of a first double cam which is formed by two cams displaced towards each other by 180°, in which each of said two cams of said double cam interacts with said locking area of said latch, respectively.

20. The foldable load carrier according to claim 19, wherein said camshaft presents a second double cam, formed by two more cams displaced towards each other by 180°, that interacts with a deactivation area of said latch, respectively.

21. The foldable load carrier according to claim 20, wherein said first double cam is displaced by an angle of 90° with respect to said second double cam.

22. The foldable load carrier according to claim 18, wherein said foldable load carrier presents a force limitation which prevents a pivoting of said lever around said pivoting axis downwards when exceeding a preset force.

23. The foldable load carrier according to claim 22, wherein said force limitation presents a detent supported pivotably around a first bearing on said lever, a tooth segment applied stationarily in relation to a central carrier of said foldable load carrier with which said detent interacts, and a prestressing element, in that said detent for its part bears a follower plate supported pivotably in said pivoting axis in a second bearing.

24. The foldable load carrier according to claim 23, wherein said first and second bearing of said detent being arranged displaced towards each other, and in that said follower plate is connected to said locking device with a transmission element for transmission of said swinging movement of said lever by a following gearing.

25. The foldable load carrier according to claim 24, wherein said transmission element includes at least one plate supported by an arm forming a bearing and protruding from a transition area of said coupling mechanism, said plate additionally being pivotably supported by a connecting rod that is pivotably connected to at least one crank latches, said crank latch defining an opening configured to receive at least a portion of said gearing of said camshaft 24.

26. The foldable load carrier according to claim 18, wherein said foldable load carrier presents a backlash-free position.

27. The foldable load carrier according to claim 26, wherein said backlash-free position presents a chamfer at a mandrel of said coupling mechanism, and a pressure piece interacting with said camshaft.

28. The foldable load carrier according to claim 27, wherein said chamfer presents an angle of substantially 1° to 2°.

29. The foldable load carrier according to claim 16 further comprising an operating unit that presents a transmission element that is off-center.

30. The foldable load carrier according to claim 29, said transition element is formed by a tube.

31. The foldable load carrier according to claim 30, wherein said coupling mechanism is provided on a central carrier having a coupling side end zone configured to be folded upwards, and said transmission element a first section configured to be folded upwards via a joint, wherein said coupling side end zone of said central carrier and said first section of said transmission element are movable in relation to each other and coincide.

32. The foldable load carrier according to claim 16 further comprising at least one carrier arm, which form said lever, wherein said carrier arm is arranged in a console, which in an unfolded state allow a tilting movement of said lever backwards, and wherein an additional security device is provided, in order to prevent an unwanted tilting backwards thereof.

33. The foldable load carrier according to claim 32, wherein said lever is a pair of levers pivotably attached on either side of a central carrier which provides said coupling mechanism, said levers are arranged rotatably around a longitudinal axis said levers, respectively.
